(19) United States
(12) Patent Application Publication
(10) Pub. No.: US 2010/0161853 A1
(43) Pub. Date: Jun. 24, 2010

(54) METHOD, APPARATUS AND SYSTEM FOR TRANSMITTING MULTIPLE INPUT/OUTPUT (I/O) REQUESTS IN AN I/O PROCESSOR (IOP)

(76) Inventors: Matthew A. Curran, Philadelphia, PA (US); Craig F. Russ, Berwyn, PA (US)

Correspondence Address: UNISYS CORPORATION, UNISYS WAY, MAIL STATION: E8-114, BLUE BELL, PA, 19424, US

(21) Appl. No.: 12/340,854

(22) Filed: Dec. 22, 2008

(51) Int. Cl. G06F 9/46

(52) U.S. Cl. 710/39

(57) ABSTRACT

A method, apparatus and system for transmitting multiple I/O requests from an input/output processor (IOP) to an I/O device. The IOP is configured with multiple I/O threads, each having a corresponding active I/O, that allow a queuing thread to coordinate the transfer of multiple I/O requests at a time from the output of the device queue to the active I/Os and their I/O threads. The queuing thread and a promotion algorithm are configured to consider the promotion of one or more I/O requests ahead of other I/O requests in the device queue, based on a set of promotion requirements. After processing by the I/O threads, multiple I/O requests are transferred at a time from the multiple active I/Os to the I/O device. Promotion of I/O requests based on the promotion requirements improves processing efficiency by making better use of the multiple I/O thread processing resources.

### BACKGROUND

1. Field

The instant disclosure relates generally to computing environments in which input/output processing is offloaded from a central processing unit (CPU) to an input/output processor (IOP), and more particularly, to sending multiple I/O requests from an IOP to input/output (I/O) devices connected to the IOP.

2. Description of the Related Art

An input/output (I/O) processor (IOP) is a device that receives I/O requests, e.g., data read requests and data write requests, from an operating system and sends the I/O requests to connected I/O devices. The operating system expects all data on an I/O device to be consistent with the order of the data read and data write operations the operating system has sent to the IOP. The easiest way to make sure that the data on an I/O device is consistent with the data requests sent from the operating system to the IOP is to send one I/O request at a time to an I/O device. However, such approach is not an optimal data transmission process if the I/O device can support multiple I/O requests at a time.

Conventionally, the IOP receives I/O requests from the operating system using one or more request queues. The operating system places I/O requests at the input end (tail) of the request queue, and the IOP retrieves I/O requests from the output end (head) of the request queue. The IOP has a queuing thread for each request queue. The queuing thread is responsible for pulling I/O requests from its associated request queue and placing the pulled I/O requests in a device queue. Each device queue has a single corresponding I/O thread that processes entries in the device queue in FIFO (first in, first out) order. After placing an I/O request in an empty device queue, the queuing thread activates or wakes up the I/O thread associated with the device queue. An I/O thread will continue to process I/O request entries in the device queue until no I/O requests are left, and then change from an “in use” state to a “waiting” state. Although this conventional configuration is functional, it does not take advantage of the performance benefits that could be gained by sending more than one I/O request to an I/O device at a time.

### SUMMARY

Therefore, it would be desirable to have available a method, apparatus and system for allowing multiple I/O requests to be sent to an I/O device at a time.

Disclosed is a method, apparatus and system for transmitting multiple I/O requests from an input/output processor (IOP) to an I/O device connected to the IOP. The IOP is configured with multiple I/O threads, each having a corresponding active I/O, that allow a queuing thread to coordinate the transfer of multiple I/O requests at a time from the output of the device queue to the active I/Os and their corresponding I/O threads. After processing by the I/O threads, multiple I/O requests are transferred at a time from the multiple active I/Os to the I/O device. The method includes queuing the I/O requests received by the IOP in a device queue based on the order received, allowing the queuing and I/O threads to pull multiple I/O requests at a time from the device queue and transferring the multiple I/O requests to multiple active I/Os and their corresponding I/O threads for processing, and sending the multiple I/O requests at a time to the I/O device. The queuing and I/O threads use a promotion algorithm to consider the promotion of one or more I/O requests ahead of other I/O requests in the device queue, based on a set of promotion requirements. The promotion of one or more I/O requests, based on the set of promotion requirements, further improves the processing efficiency of the IOP by making better use of the multiple processing resources provided by the multiple I/O threads and their corresponding active I/Os. Despite the improved processing efficiency, the promotion of one or more I/O requests ahead of other I/O requests in the device queue does not disrupt the appearance of the order of the data on the I/O device resulting from the execution of the I/O requests delivered to the I/O device. Unlike the IOPs in the disclosed method, apparatus and system for transmitting multiple I/O requests from an input/output processor (IOP) to an I/O device connected to the IOP, conventional IOPs have only one I/O thread (with no corresponding active I/O) and therefore are not capable of taking advantage of I/O devices that can receive multiple I/O requests at a time, e.g., by sending multiple I/O requests at a time to the particular I/O device. Also, conventional IOPs do not have any I/O request promotion scheme for further improving I/O request efficiency.

### BRIEF DESCRIPTION OF THE DRAWINGS

FIG. 1 is a schematic view of a conventional computing environment involving an input/output processor (IOP) receiving I/O requests from an operating system and sending I/O requests to a connected I/O device;

FIG. 2 is a schematic view of a computing environment involving an IOP sending multiple I/O requests to a connected I/O device according to an embodiment;

FIG. 3 is a flow diagram of a portion of the operation of the queuing thread and/or promotion algorithm within the IOP according to an embodiment;

FIG. 4 is a flow diagram of a portion of the operation of the I/O threads and corresponding active I/Os within the IOP according to an embodiment;

FIG. 5 is a flow diagram of a method for sending multiple I/O requests from an IOP to a connected I/O device according to an embodiment; and

FIG. 6 is a flow diagram of a portion of the method illustrated in FIG. 5, in which I/O requests are considered for promotion according to an embodiment.

### DETAILED DESCRIPTION

In the following description, like reference numerals indicate like components to enhance the understanding of the disclosed method, apparatus and system for transmitting multiple I/O requests from an input/output processor (IOP) to an I/O device connected to the IOP through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

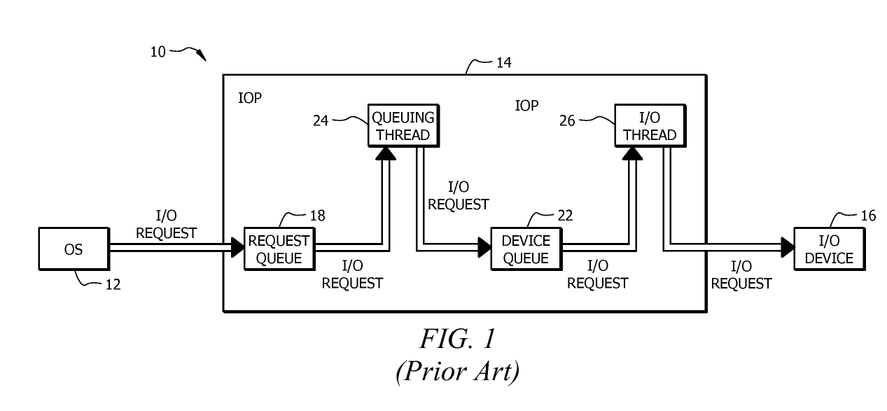

FIG. 1 is a schematic view of an embodiment of a conventional computing environment 10 involving an input/output processor (IOP) receiving I/O requests from an operating system and sending I/O requests to a connected I/O device. The computing environment 10 includes an operating system 12, an IOP 14 coupled to the operating system, and an I/O device 16 coupled or connected to the IOP 14. The operating system 12 can be any suitable operating system within a computing environment, such as a mainframe computer operating system. As discussed hereinabove, the IOP 14 is a device provided to offload input/output processing from a central processing unit (CPU) within the computing environment 10. The IOP 14 receives I/O requests from the operating system, which includes instructions executed by the CPU, and sends or transmits the I/O requests to the appropriate I/O device 16. The I/O device 16 can be any suitable I/O device, such as a network element or a data drive.

The IOP 14 typically includes at least one request queue 18 and at least one device queue 22. The IOP 14 also typically includes a queuing thread 24 that corresponds to the request queue 18. The queuing thread 24 controls various aspects of the operation of the request queue 18 and the device queue 22. The IOP 14 also typically includes an I/O thread 26 that corresponds to or is associated with the device queue 22. The I/O thread 26 controls various aspects of the operation of the device queue 22 and the transmission of I/O requests to the I/O device 16.

The request queue 18 is a data structure that receives I/O requests from the operating system 12. As discussed hereinabove, the queuing thread 24 pulls or removes I/O requests from the output end (head) of the associated request queue 18 and places the I/O requests in the input end (tail) of the device queue 22. When the queuing thread 24 places an I/O request in a device queue 22 that is empty, the queuing thread 24 activates the lone I/O thread 26 associated with that particular device queue 22. The I/O thread 26, which operates in a first-in, first-out (FIFO) manner, pulls or removes an I/O request from the output end of the associated device queue 22, processes the I/O request, and delivers or transmits the processed I/O request to the appropriate I/O device 16. Such activity continues until the device queue no longer has any I/O requests therein.

As discussed hereinabove, the conventional computing environment 10 is functional, but does not take advantage of I/O devices that can receive multiple I/O requests at a time, e.g., by sending multiple I/O requests at a time to the particular I/O device. To allow multiple I/O requests to be sent to an I/O device at a time, more than one I/O request should be allowed to be pulled from a device queue at a time. Also, as long as certain conditions are met, the I/O requests should be allowed to be performed or executed out of order, e.g., to improve overall processing efficiency. However, the data on the I/O device resulting from the execution or performance of the I/O requests should, at all times, appear to the operating system to be consistent with the order the operating system sent the I/O requests to the IOP.

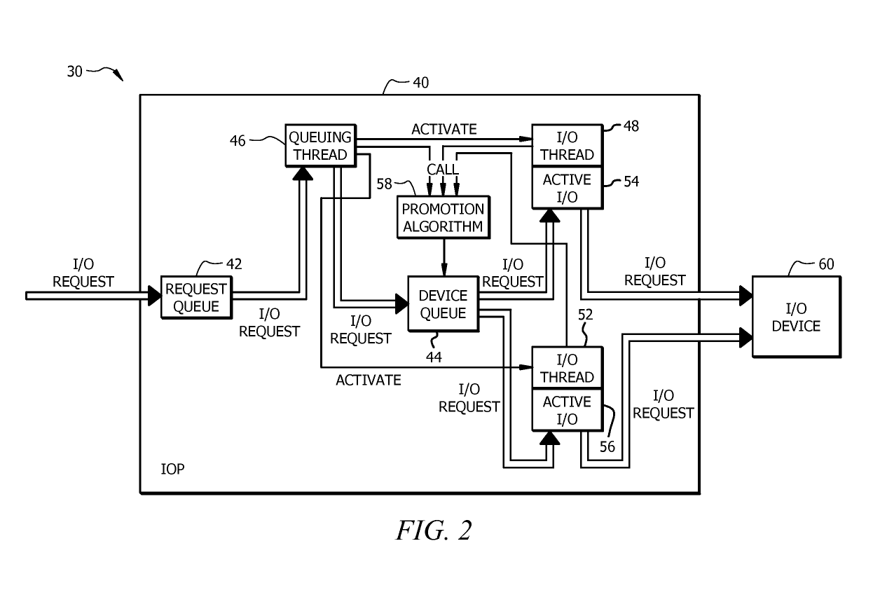

FIG. 2 illustrates an exemplary schematic view of a computing environment 30 involving an IOP 40, configured according to an embodiment, sending multiple I/O requests to an I/O device 60 connected to the IOP 40. Similar to a conventional IOP, e.g., the IOP 14 illustrated in FIG. 1, the IOP 40 includes at least one request queue 42 and at least one device queue 44. The IOP 40 also includes a queuing thread 46, although the queuing thread 46 is configured differently and operates differently than conventional queuing threads, such as the conventional queuing thread 24 illustrated in FIG. 1 and discussed hereinabove.

Unlike conventional IOPs that have a single I/O thread per device queue, the IOP 40 includes multiple I/O threads per device queue, such as a first I/O thread 48 and a second I/O thread 52 associated with the device queue 44. Also, according to an embodiment, each I/O thread includes a corresponding active I/O, which, as will be discussed hereinbelow, is configured to keep track of whether or not the corresponding I/O thread is busy and, if so, which I/O request the corresponding I/O thread currently is performing or executing. For example, the first I/O thread 48 includes a first active I/O 54 that couples the first I/O thread 48 to the device queue 44, and the second I/O thread 52 includes a second active I/O 56 that couples the second I/O thread 52 to the device queue 44.

The IOP 40 also includes a promotion algorithm (illustrated generally as 58) to assist in controlling the movement of I/O requests from the device queue 44 to an appropriate one of the active I/Os. As will be discussed in greater detail hereinbelow, the promotion algorithm 58 includes a set of promotion requirements that assist in making sure that data written to and read from the I/O device 60 is consistent with the order of the data read and data write operations of the I/O requests sent by the operating system to the I/O device 60 via the IOP 40, even if I/O requests are not always processed by the IOP 40 in sequential (FIFO) order, as will be discussed hereinbelow.

It should be understood that the IOP 40 as illustrated in FIG. 2 includes data flows of I/O requests between various components within the IOP 40 and external to the IOP 40. The IOP 40 also includes instructional or informational flows between various components within the IOP 40. For example, I/O request data flows are illustrated between the request queue 42 and the queuing thread 46, between the queuing thread 46 and the device queue 44, between the device queue 44 and the active I/Os, e.g., active I/O 54 and active I/O 56, and between the active I/Os and the I/O device 60. Also, various instructional or informational flows are illustrated between components with IOP 40. For example, one or more activate or wake up instructional flows are illustrated from the queuing thread 46 to the I/O threads, and a call instructional flow is illustrated from the queuing thread 46 to the promotion algorithm 58. Also, instructional “call” flows from the queuing thread 46 and the I/O threads to the promotion algorithm 58 can result in the promotion algorithm 58 instructing the device queue 44 to move an I/O request from the device queue 44 to one of the active I/Os.

One or more of the request queue 42, the device queue 44, the queuing thread 46, the I/O threads 48 and 52, the active I/Os 54 and 56, and the promotion algorithm 58 can be comprised partially or completely of any suitable structure or arrangement, e.g., one or more integrated circuits. Also, it should be understood that the IOP 40 can include other components, hardware and software (not shown) that are used for the operation of other features and functions of the IOP 40 not specifically described herein.

All relevant portions of the IOP 40, including the request queue 42, the device queue 44, the queuing thread 46, the I/O threads 48 and 52, the active I/Os 54 and 56, and the promotion algorithm 58, can be partially or completely configured in the form of hardware circuitry and/or other hardware components within a larger device or group of components. Alternatively, all relevant portions of the IOP 40, including the request queue 42, the device queue 44, the queuing thread 46, the I/O threads 48 and 52, the active I/Os 54 and 56, and the promotion algorithm 58, can be partially or completely configured in the form of software, e.g., as processing instructions and/or one or more sets of logic or computer code. In such configuration, the logic or processing instructions typically are stored in a memory element or a data storage device. The data storage device typically is coupled to a processor or controller, and the controller accesses the necessary instructions from the data storage element and executes the instructions or transfers the instructions to the appropriate location within the respective device.

As in conventional IOPs, the request queue 42 in the IOP 40 receives I/O requests, e.g., from an operating system (not shown). The queuing thread 46 is responsible for moving the I/O requests received by the request queue 42 to the device queue 44. However, in conventional IOPs, for each device queue there is a single I/O thread that, upon activation by the queuing thread, removes an I/O request from the output end of the device queue and delivers the I/O request to the I/O thread. The I/O thread processes the I/O request and sends the I/O request to the I/O device coupled to the IOP. However, to deliver multiple I/O requests at a time to the I/O device, the IOP 40 is configured with multiple I/O threads per device queue to allow multiple I/O requests to be pulled from the device queue at a time (not necessarily in sequential order) and delivered to multiple I/O threads for processing before sending the multiple I/O requests to the I/O device. Each of the multiple I/O threads (per device queue) includes a corresponding active I/O to keep track of the activity and performance of its corresponding I/O thread. Also, the queuing thread 46 is configured to coordinate the movement of the multiple I/O requests from the device queue 44 to the I/O threads. The queuing thread 46 also can be assisted by the promotion algorithm 58, e.g., in determining whether various I/O requests qualify for promotion ahead of other I/O requests.

As discussed briefly hereinabove, each of the multiple I/O threads per device queue has a corresponding active I/O coupled thereto. In general, each active I/O keeps track of whether or not its corresponding I/O thread is busy and what I/O request its corresponding I/O thread currently is performing if the I/O thread is busy. For example, each of the active I/Os can be configured to have two states: a first “In Use” state and a second “Free” state. When an active I/O is in the first “In Use” state, the active I/O contains or includes appropriate information related to the particular I/O request that its corresponding I/O thread is executing. When an active I/O is in the second “Free” state, its corresponding I/O thread is available to perform an I/O request.

As discussed briefly hereinabove, the promotion algorithm 58 is configured to assist the queuing thread 46 in promoting I/O requests from the device queue 44 to the active I/O of an appropriate one of the multiple I/O threads. In operation, the queuing thread 46 can call the promotion algorithm 58 after the queuing thread 46 has added an I/O request to the device queue 44. Also, an I/O thread can call the promotion algorithm 58 to promote an I/O request to its corresponding active I/O.

As will be discussed in greater detail hereinbelow, the operation of promoting an I/O request from the device queue 44 to an active I/O can include promoting an I/O request from the device queue 44 to an active I/O before or ahead of at least one other I/O request that was delivered to the device queue 44 prior to that of the promoted I/O request pulled from the device queue 44. That is, at least one I/O request is pulled or removed from the output end of the device queue 44 before at least one other I/O request that was delivered to the input end of the device queue 44 prior to the pulled I/O request being delivered to the input end of the device queue 44. Therefore, the order in which a plurality of I/O requests are promoted from the output end of the device queue 44 can differ from the order in which those same I/O requests were delivered to the input end of the device queue 44.

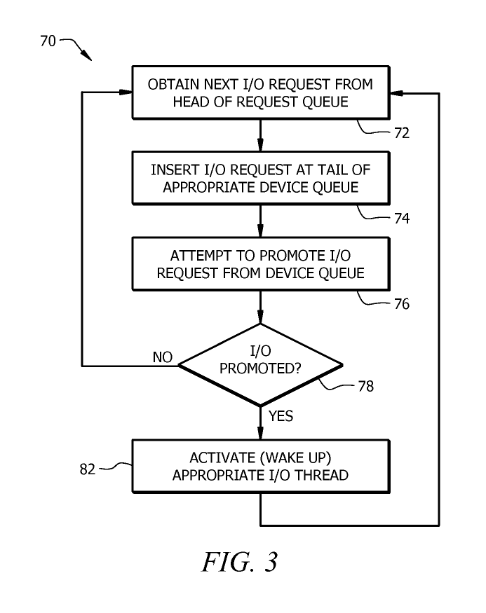

FIG. 3 illustrates a flow diagram 70 of a portion of the operation of the queuing thread 46 and/or the promotion algorithm, involving the addition of an I/O request to the device queue 44. The method for the queuing thread 46 adding an I/O request to the device queue 44 involves a first step 72 of the queuing thread 46 pulling the next I/O request from the output end (head) of the request queue 42. The method also includes a step 74 of the queuing thread 46 inserting or placing the pulled I/O request at the input end (tail) of the device queue 44.

The method also includes a step 76 of attempting to promote an I/O request from the device queue 44. When the queuing thread 46 puts an I/O request in the device queue 44, the queuing thread 46 attempts to promote the first possible I/O request from the device queue 44 to the active I/O of an appropriate I/O thread, starting from the output end (head) of the device queue 44. Also, the promotion algorithm 58, when called from an I/O thread, attempts to promote the first possible I/O request from the device queue 44 to its corresponding active I/O, also starting from the output end of the device queue 44. These promotion attempts continue until an I/O request is promoted, a threshold is reached, e.g., half of the length of the I/O request queue is examined for possible promotion, or a condition in the device queue 44 exists that ends the promotion attempts (as will be discussed in greater detail hereinbelow).

The method also includes a step 78 of determining whether the particular I/O request was actually promoted from the device queue 44 to an active I/O. If the particular I/O request selected for attempted promotion was not promoted from the device queue 44 to an active I/O (N), the method returns to the step 72 of the queuing thread 46 pulling the next I/O request from the output end of the request queue 42.

The method also includes a step 82 of activating an appropriate I/O thread or signaling an appropriate I/O thread to wake up. If the determining step 78 determines that the particular I/O request selected for attempted promotion was promoted from the device queue 44 to an active I/O (Y), the method queuing thread 46 activates or wakes up the I/O thread whose active I/O received the promoted I/O request. Such activation is illustrated generally in FIG. 2 by an activation instructional flow from the queuing thread 46 to the appropriate I/O thread. Once the queuing thread 46 activates or wakes up the appropriate I/O thread corresponding to the active I/O that received the promoted I/O request, the method returns to the step 72 of the queuing thread 46 pulling the next I/O request from the output end of the request queue 42.

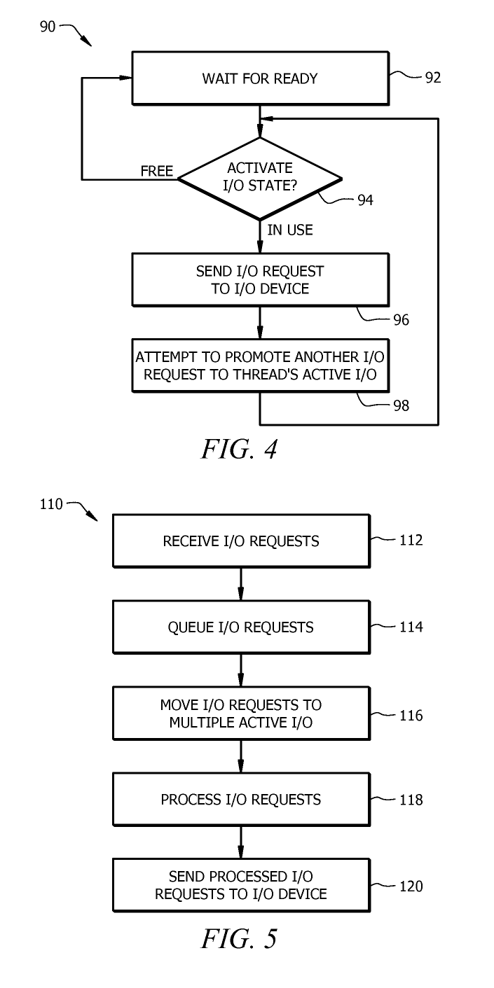

FIG. 4 illustrates an exemplary flow diagram 90 of a portion of the operation of the I/O threads, and their corresponding active I/Os, within the IOP 40 according to an embodiment. With respect to each I/O thread, the operation of the I/O thread includes an initial “Ready” or “Wait for Ready” step 92. The step 92 indicates that the particular active I/O corresponding to the I/O thread is ready to accept an I/O request from the device queue 44.

The I/O thread operation illustrated in FIG. 4 also includes a step 94 of determining the state of the active I/O corresponding to the I/O thread. As discussed hereinabove, each active I/O keeps track of whether its corresponding I/O thread is busy (“In Use”) or not busy (“Free”), including during any attempts to promote an I/O request from the device queue 44. If no I/O request is promoted to the particular I/O thread's active I/O, the operation returns to the step 92 of the I/O thread being ready to accept an I/O request from the device queue 44. The I/O thread does not become busy (“In Use”) until the active I/O is ready and an I/O request is promoted to the active I/O.

The I/O thread operation illustrated in FIG. 4 also includes a step 96 of sending an I/O request to the I/O device 60. If the active I/O indicates that its corresponding I/O thread is busy (“In Use”), i.e., the I/O thread is processing an I/O request. Upon completion of the I/O request processing, the I/O thread and its corresponding active I/O then sends the I/O to the I/O device 60. The sending step 96 can include the operation of waiting for the completion of the I/O request to be sent to the I/O device before further operation of the I/O thread and its corresponding active I/O continues.

The I/O thread operation illustrated in FIG. 4 also includes a step 98 of attempting to promote the next I/O request to the I/O device 60. Once an I/O thread and its corresponding active I/O has completed the transmission of an I/O request to the I/O device 60, the I/O thread, using the promotion algorithm 58, attempts to promote the next I/O request from the device queue 44 to the active I/O corresponding to the I/O thread and subsequently on to the I/O device 60. The I/O thread operation then returns to the active I/O state determining step 94, and the operation of the I/O thread and its corresponding active I/O continues, e.g., as discussed hereinabove.

With regard to promotion of an I/O request from the device queue 44 to an appropriate active I/O, it should be noted that the queuing thread 46 can promote an I/O request to any active I/O whose corresponding I/O thread is not busy, i.e., any active I/O with a “Free” operational state with respect to its corresponding I/O thread. However, an I/O thread can only promote an I/O request to its corresponding active I/O, for transmission to the I/O device 60.

According to the exemplary I/O thread operation illustrated in FIG. 4, I/O requests within the device queue 44 can be promoted in a different order than the I/O requests were delivered to the device queue 44. In a conventional IOP, I/O requests within the device queue 44 are pulled from the output end of the device queue 44 in FIFO order by the lone I/O thread. Therefore, any first I/O request that is delivered to the input end of the device queue 44 before any second or third I/O request is delivered to the input end of the device queue 44 always will be pulled from the output end of the device queue 44 prior to the second or third I/O request being pulled from the output end of the device queue 44. However, according to the I/O thread operation illustrated in FIG. 4, I/O requests can be pulled from the output end of the device queue in any suitable order, subject to a set of promotion requirements.

To be promoted from the device queue 44 to one of the plurality of active I/Os, an I/O request should meet a set of promotion requirements. If any one of the promotion requirements is not met, the I/O request being considered for promotion will not be promoted ahead of any other I/O requests before it in the device queue 44. Also, there are several conditions that the I/O request being considered for promotion must meet, otherwise no I/O requests currently in the device queue 44 will be promoted, including the I/O request currently being considered for promotion. The queuing thread 46 and the I/O threads, using the promotion algorithm 58, are responsible for determining whether an I/O request being considered for promotion satisfies the set of promotion requirements and conditions.

One requirement of the set of promotion requirements is that no data read I/O request can be promoted if the data read I/O request overlaps any data write I/O request in any of the active I/Os that are “In Use” or if there is an overlapping data write I/O request before or ahead of the data read I/O request in the device queue 44. I/O requests overlap if the physical areas on a data storage device that the I/O requests are reading from or writing to are not completely separate. Thus, if two I/O requests are reading and/or writing from the same physical area on the same data storage device, the two I/O requests are considered to overlap.

Accordingly, in this first promotion requirement, if a data read I/O request is being considered for promotion, there can be no overlapping data write I/O requests ahead of the data read I/O request in the device queue 44. That is, there can be no overlapping data write I/O requests that were delivered to the input end of the device queue 44 before the data read I/O request considered for promotion was delivered to the input end of the device queue 44. Also, for a data read I/O request being considered for promotion, there can be no overlapping data write I/O requests in any of the “In Use” active I/Os. As discussed hereinabove, the operational state of an active I/O is “In Use” if its corresponding I/O thread currently is performing or executing an I/O request. Therefore, for a data read I/O request being considered for promotion, there can be no overlapping data write requests being performed in any of the I/O threads. Otherwise, the data read I/O request being considered for promotion will not be promoted.

Another requirement of the set of promotion requirements is that no data write I/O request can be promoted if the data write I/O request considered for promotion overlaps any data read I/O request or any other data write I/O request in any of the “In Use” active I/Os, or if the data write I/O request being considered for promotion has ahead of it in the device queue 44 an overlapping data read I/O request or an overlapping data write I/O request. That is, a data write I/O request will not be promoted to an active I/O if any other active I/Os are busy with an overlapping data read or date write I/O request. Also, no data write I/O request will be promoted ahead of any overlapping data read I/O requests or data write I/O requests in the device queue 44.

One of the conditions that must be met to keep all of the I/O requests in the device queue 44 from not being promoted involves whether or not any of the active I/Os contain an I/O request that is not a data read I/O request or a data write I/O request. Such I/O requests include power down requests, device attribute requests and other suitable non-read and non-write I/O requests. If any of the active I/Os includes an I/O request that is not a data read I/O request or not a data write I/O request, then not only will the I/O request being considered for promotion not be promoted, but no other I/O request currently in the device queue 44 will be promoted. Therefore, if any of the active I/Os includes an I/O request that is not a data read I/O request or not a data write I/O request, no I/O request currently in the device queue 44 will be promoted ahead of any other I/O request currently in the device queue 44.

Another condition that must be met to keep all of the I/O requests in the device queue 44 from not being promoted involves whether, for an I/O request being considered for promotion that is not a data read I/O request or a data write I/O request, if there is any I/O request ahead of the I/O request being considered for promotion in the device queue 44. If the I/O request being considered for promotion is not a data read I/O request or a data write I/O request, and there is an I/O request ahead of the I/O request being considered for promotion in the device queue 44, then not only will the I/O request being considered for promotion not be promoted, but no other I/O request currently in the device queue 44 will be promoted. Therefore, if the I/O request being considered for promotion is not a data read I/O request or a data write I/O request, and there is an I/O request ahead of the I/O request being considered for promotion in the device queue 44, no I/O request currently in the device queue 44 will be promoted ahead of any other I/O request currently in the device queue 44.

Yet another condition that must be met to keep all of the I/O requests in the device queue 44 from not being promoted involves whether, for an I/O request being considered for promotion that is not a data read I/O request or a data write I/O request, if there is any I/O request in any active I/O, i.e., if any active I/O is “in use.” If the I/O request being considered for promotion is not a data read I/O request or a data write I/O request, and there is an I/O request in any of the active I/Os, then not only will the I/O request being considered for promotion not be promoted, but no other I/O request currently in the device queue 44 will be promoted. Therefore, if the I/O request being considered for promotion is not a data read I/O request or a data write I/O request, and if there is an I/O request in any of the active I/Os, then no I/O request currently in the device queue 44 will be promoted ahead of any other I/O request currently in the device queue 44.

In addition to the promotion requirements and conditions just described, there is also the additional condition or requirement that an I/O request will not be skipped over too many times by promoted I/O requests. That is, all I/O requests being considered for promotion in the device queue 44 cannot be promoted over an I/O request that already has been skipped over too many times, e.g., by previously promoted I/O requests. The number of times an I/O request can be skipped over can be set by an appropriate threshold value. Each I/O request has associated therewith a skip count. Each time an I/O request is promoted, the skip count of every I/O request that was skipped over by the promoted I/O request is incremented by a value of one. When the skip count for a given I/O request reaches an appropriate threshold level, that particular I/O request no longer can be skipped over by another I/O request, even by an I/O request meets all of the other promotion requirements.

If an I/O request being considered for promotion meets all of the promotion requirements, the queuing thread 46 will promote the I/O request ahead of the one or more I/O requests that were delivered to the input of the device queue 44 before the I/O request being promoted. In this manner, the promoted I/O request will skip over the I/O requests ahead of it in the device queue 44 and be transferred from the output end of the device queue 44 to one of the active I/Os. As discussed hereinabove, the skip count for each of the I/O requests skipped over by the promoted I/O request will be incremented by a value of one. Also, the queuing thread 46 will activate the I/O thread of the active I/O receiving the promoted I/O request. Therefore, the I/O thread can process the promoted I/O request as necessary for subsequent promotion from its corresponding active I/O to the I/O device 60.

In the embodiments discussed hereinabove, typically the queuing thread 46 is configured to attempt to promote an I/O request after placing the I/O request in the device queue 44, with assistance as needed from the promotion algorithm 58. According to alternative embodiments, one or more of the I/O threads are configured to attempt to promote an I/O request from the device queue 44. In this manner, the queuing thread 46 activates an I/O thread with a “free” active I/O. The activated I/O thread, immediately after being activated, begins determining if promotion is proper for the I/O request being considered for promotion. It should be understood that the I/O threads configured to determine promotion of I/O requests can be configured in this manner either instead of or in addition to the queuing thread 46 being configured to determine I/O request promotion.

FIG. 5 illustrates an exemplary method 110 for sending multiple I/O requests from an IOP to a connected I/O device according to embodiments. The method 110 includes a step 112 of receiving I/O requests. As discussed hereinabove, the IOP 40 includes at least one request queue 42 that receives I/O requests, e.g., from an operating system.

The method 110 also includes a step 114 of queuing the I/O requests. As discussed hereinabove, the queuing thread 46 is configured to move I/O requests received by the request queue 42 to the input end of the device queue 44. The device queue 44 typically queues the I/O requests in the order in which the I/O requests were delivered thereto.

The method also includes a step 116 of moving multiple I/O requests at a time to the multiple active I/Os. As discussed hereinabove, the IOP 40 is configured with multiple I/O threads per device queue, with each I/O thread having a corresponding active I/O. The queuing thread 46 is configured to coordinate the movement of the multiple I/O requests at a time from the device queue 44 to the I/O threads, making use of the active I/Os corresponding to each I/O thread. The queuing thread 46 can be assisted by the promotion algorithm 58 for determining possible promotions of I/O requests from the device queue 44 to various active I/Os and corresponding I/O threads.

The method 110 also includes a step 118 of processing I/O requests. I/O requests moved from the output end of the device queue 44 to one of the active I/Os are processed by the I/O thread corresponding to the active I/O. The I/O thread can process the I/O request in any suitable manner, e.g., according to conventional I/O thread processes.

The method 110 also includes a step 120 of sending processed I/O requests to the I/O device. The I/O thread sends the processed I/O request to the I/O device coupled to the IOP. As discussed hereinabove, according to some embodiments, the IOP 40 has multiple I/O threads, each with a corresponding active I/O. Therefore, multiple I/O requests can be processed at a time and, in turn, sent by the multiple I/O threads to the I/O device at a time. In this manner, the IOP 40 is better suited to take advantage of I/O devices that can support multiple I/O requests at a time by sending multiple I/O requests at a time to the I/O device.

As discussed hereinabove, the moving step 116 moves I/O requests from the device queue 44 to the plurality of active I/Os and their corresponding I/O threads for processing by the I/O threads. In this manner, multiple I/O requests can be processed at a time and subsequently sent to the I/O device 60 at a time. Typically, the I/O requests are moved from the output end of the device queue 44 to the active I/Os in sequential order, e.g., in the same order in which the queuing thread 46 delivered the I/O requests to the input end of the device queue 44. However, sometimes the efficiency of the movement of I/O requests out of the device queue 44 can be further improved by moving certain I/O requests ahead of other I/O requests in the device queue 44 for earlier transfer to one of the active I/Os. That is, sometimes it is more efficient for an I/O request to skip over one or more I/O requests that may be ahead of the I/O request in the device queue 44 for transfer to one of the active I/Os. As discussed hereinabove, the queuing thread 46 and the I/O threads use the promotion algorithm 58 to determine whether I/O requests considered for promotion qualify for such movement or skipping ahead of other I/O requests.

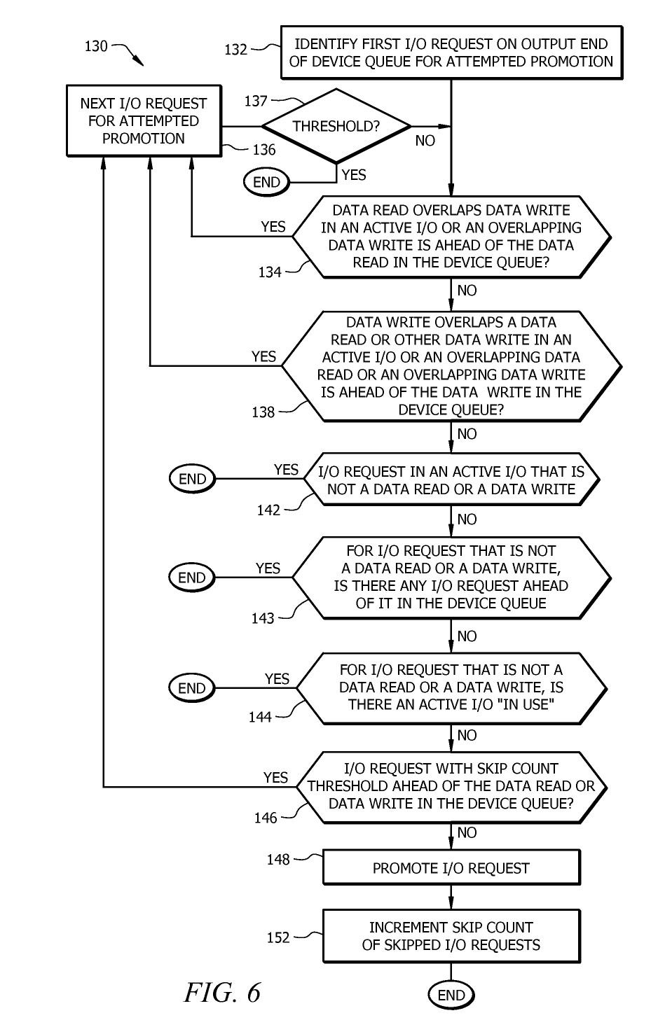

FIG. 6 illustrates a flow diagram of an exemplary promotion algorithm portion 130 of the moving step 116, in which I/O requests are considered for promotion ahead of other I/O requests according to embodiments. The promotion algorithm 130 includes a step 132 of identifying an I/O request for consideration for promotion ahead of other I/O requests. Among the I/O requests queued in the device queue 44, certain I/O requests may be considered for possible movement ahead of other I/O requests, i.e., for skipping over other I/O requests ahead thereof in the I/O request queue within the device queue 44. As discussed hereinabove, possible promotion of an I/O request begins with the I/O request at the output end (head) of the device queue 44 and does not stop until an I/O request is promoted, a threshold is reached, e.g., half of the length of the I/O request queue is examined for possible promotion, or a condition in the device queue 44 exists that ends the promotion algorithm 130.

In the illustrated embodiment, the promotion algorithm 130 includes a first requirement step 134 for determining whether the identified I/O request is to be promoted. Once an I/O request is identified as a candidate for possible promotion, the first requirement step 134 is performed to determine whether the identified I/O request continues to be a candidate for promotion. The first requirement involves conditions that apply only to a data read I/O request. The first requirement is that no data read I/O request can be promoted if the data read I/O request overlaps a data write I/O request in any of the active I/Os or if there is an overlapping data write I/O request ahead of the data read I/O request in the device queue.

If the identified I/O request is not a data read I/O request, the first requirement step 134 does not apply and the promotion algorithm 130 moves to the next requirement step. However, if the identified I/O request is a data read I/O request, and it overlaps a data write I/O request in at least one of the active I/Os, or if there is a data write I/O request ahead of the data read I/O request in the device queue (Y), then the identified I/O request does not meet the conditions of the first requirement. Accordingly, the identified I/O request will not be promoted. The promotion algorithm 130 then proceeds to a step 136 of moving to the next I/O request in the device queue 44 for consideration for promotion.

The promotion algorithm 130 then proceeds to a determination 137 of whether or not a threshold has been met, i.e., if a certain number of I/O requests within the device queue 44 have been considered for promotion. If the threshold has not been met (N), the promotion algorithm 130 proceeds to the first requirement step 134. If the threshold has been met (Y), the promotion algorithm 130 ends.

However, if the identified I/O request is a data read I/O request, but does not overlap a data write I/O request in any of the active I/Os, and there is not an overlapping data write I/O request ahead of the identified data read I/O request in the device queue (N), then the identified I/O request meets the conditions of the first requirement, and the promotion algorithm 130 moves to the next requirement step. It should be understood that the promotion requirements described herein can be performed in any suitable order.

The exemplary promotion algorithm 130 includes a second requirement step 138 for determining whether the identified I/O request is to be promoted. If the identified I/O request meets the conditions of the first requirement step, or if the first requirement does to apply to the identified I/O request, the second requirement step 138 is performed to determine whether the identified I/O request continues to qualify for promotion. The second requirement involves conditions that apply only to a data write I/O request. The second requirement is that no data write I/O request can be promoted if the data write I/O request overlaps a data read I/O request or another data write I/O request in any of the active I/Os or if there is an overlapping data read I/O request or an overlapping data write I/O request ahead of the identified data write I/O request in the device queue.

If the identified I/O request is not a data write I/O request, the second requirement step 138 does not apply and the promotion algorithm 130 moves to the next requirement step. If the identified I/O request is a data write I/O request, and overlaps either a data read I/O request or another data write I/O request in at least one of the active I/Os, or if there is either an overlapping data read I/O request or an overlapping data write I/O request ahead of the identified data write I/O request in the device queue (Y), then the identified I/O request does not meet the conditions of the second requirement. Accordingly, the identified I/O request will not be promoted. The promotion algorithm 130 then proceeds to the next I/O request for consideration for promotion (step 136). However, if the identified I/O request is a data write I/O request, but does not overlap either a data read I/O request or another data write I/O request in any of the active I/Os, and there is not an overlapping data read I/O request or an overlapping data write I/O request ahead of the identified data write I/O request in the device queue (N), then the identified I/O request meets the conditions of the second requirement, and the promotion algorithm 130 moves to the next requirement step.

The promotion algorithm 130 also includes several conditions or conditional steps that will cause no I/O requests currently in the device queue 44 to be promoted. For example, the promotion algorithm 130 includes a requirement step 142 for determining if no I/O requests will be promoted. If the identified I/O request meets the conditions of the second requirement step, or if the second requirement does not apply to the identified I/O request, the requirement step 142 is performed to determine whether or not the identified I/O request continues to qualify for promotion. The requirement step 142 involves whether or not any of the active I/Os contain an I/O request that is not a data read I/O request or a data write I/O request. The third requirement is that no active I/O can contain an I/O request that is not a data read I/O request or a data write I/O request.

If none of the active I/Os includes an I/O request that is not a data read I/O request or not a data write I/O request (N), the requirement step 142 does not apply and the promotion algorithm 130 moves to the next requirement step. However, if any of the active I/Os includes an I/O request that is not a data read I/O request or not a data write I/O request (Y), then not only will the identified I/O request not be promoted, but no other I/O request currently in the device queue 44 will be promoted. Therefore, if any of the active I/Os includes an I/O request that is not a data read I/O request or not a data write I/O request, the promotion algorithm 130 ends.

The promotion algorithm 130 includes another requirement step 143 for determining if no I/O requests will be promoted. If the conditions of the requirement step 142 do not apply, then the requirement step 143 is performed to determine whether or not the identified I/O request continues to qualify for promotion. The requirement step 143 involves whether, for an identified I/O request that is not a data read I/O request or a data write I/O request, if there is any I/O request ahead of the identified I/O request in the device queue 44.

If the identified I/O request is a data read I/O request or a data write I/O request, the requirement step 143 does not apply and the promotion algorithm 130 moves to the next requirement step. If the identified I/O request is not a data read I/O request or a data write I/O request, and if there is no I/O request ahead of the identified I/O request in the device queue 44 (N), then the promotion algorithm 130 moves to the next requirement step. However, if the identified I/O request is not a data read I/O request or a data write I/O request, and there is an I/O request ahead of the identified I/O request in the device queue 44 (Y), then not only will the identified I/O request not be promoted, but no other I/O request currently in the device queue 44 will be promoted. Therefore, if the identified I/O request is not a data read I/O request or a data write I/O request, and there is an I/O request ahead of the identified I/O request in the device queue 44 (Y), the promotion algorithm 130 ends.

The promotion algorithm 130 includes yet another requirement step 144 for determining if no I/O request is to be promoted. If the conditions of the requirement step 144 do not apply, then the requirement step 144 is performed to determine whether or not the identified I/O request continues to qualify for promotion. The requirement step 144 involves whether, for an identified I/O request that is not a data read I/O request or a data write I/O request, if there is any I/O request in any active I/O, i.e., if any active I/O is “in use.”

If the identified I/O request is a data read I/O request or a data write I/O request, the requirement step 144 does not apply and the promotion algorithm 130 moves to the next requirement step. If the identified I/O request is not a data read I/O request or a data write I/O request, and if there is no I/O request in any of the active I/Os (N), then the promotion algorithm 130 moves to the next requirement step. However, if the identified I/O request is not a data read I/O request or a data write I/O request, and there is an I/O request in any of the active I/Os (Y), then not only will the identified I/O request not be promoted, but no other I/O request currently in the device queue 44 will be promoted. Therefore, if the identified I/O request is not a data read I/O request or a data write I/O request, and there is an I/O request in any of the active I/Os (Y), the promotion algorithm 130 ends.

The promotion algorithm 130 includes another requirement step 146 for determining whether the identified I/O request is to be promoted. If the identified I/O request meets the conditions of the previous requirement steps, or if the previous requirements do not apply to the identified I/O request, the requirement step 146 is performed to determine whether the identified I/O request qualifies for promotion. The requirement is that the identified I/O request cannot be promoted if any I/O request ahead of the identified I/O request in the device queue has a skip count that meets an appropriate threshold level. As discussed hereinabove, each time an I/O request is skipped by a promoted I/O request, the skip count of the I/O request that was skipped is incremented by a value of one. If the skip count of an I/O request reaches an appropriate threshold level, e.g., five, the I/O request no longer can be skipped by any other I/O request, even if the other I/O request otherwise qualifies for promotion, i.e., by meeting the requirements of all of the other promotion requirements.

If the identified I/O request has ahead of it in the device queue an I/O request with a skip count meeting an appropriate threshold level (Y), then the identified I/O request does not meet the conditions of the sixth requirement. Accordingly, the identified I/O request will not be promoted. The promotion algorithm 130 then proceeds to the next I/O request for consideration for promotion (step 136). However, if the identified I/O request has no I/O requests ahead of it in the device queue that have a skip count meeting an appropriate threshold level (N), the identified I/O request meets the conditions of the sixth requirement, and the promotion algorithm 130 moves to the next step.

The promotion algorithm 130 includes a step 148 of promoting the identified I/O request. If the identified I/O request meets all of the promotion requirements, e.g., as set forth in process steps 134-146, the identified I/O request qualifies for promotion. Accordingly, the identified I/O request will be promoted from the device queue 44 to an appropriate active I/O, such as the first active I/O 54 or the second active I/O 56, e.g., as determined by the queuing thread 46 or an I/O thread using the promotion algorithm 58.

The promotion process 130 then proceeds to a step 152 of incrementing the skip count of any I/O requests that were skipped as a result of the identified I/O request being promoted. As discussed hereinabove, when the skip count for any I/O request reaches an appropriate threshold level, that particular I/O request no longer can be skipped over by another I/O request, even by an I/O request meets all of the other promotion requirements and conditions.

It should be understood that the promotion requirements collectively do not disrupt the appearance of the order of the data on the I/O device resulting from the execution of the I/O requests delivered to the I/O device, even if one or more I/O requests are promoted in a manner that skips over one or more other I/O requests in the device queue. Thus, even though I/O requests that are delivered from the operating system to the IOP in a specific order may be performed out of order, the data on the I/O device resulting from the execution of the I/O requests is not inconsistent with the order the operating system sent I/O requests to the IOP, as long as the I/O request promotion adheres to the conditions of all of the promotion requirements.

As discussed hereinabove, conventional computing environment are functional, but do not take advantage of I/O devices that can receive multiple I/O requests at a time, e.g., by sending multiple I/O requests at a time to the particular I/O device. To allow multiple I/O requests to be sent to an I/O device at a time, more than one I/O request should be allowed to be pulled from a device queue at a time. Also, as long as certain conditions are met, the I/O requests should be allowed to be performed or executed out of order. However, the data on the I/O device resulting from the execution or performance of the I/O requests delivered to the I/O device should, at all times, appear to the operating system to be consistent with the order the operating system sent the I/O requests to the IOP.

The methods illustrated in FIGS. 3-6 may be implemented in a general, multi-purpose or single purpose processor. Such a processor will execute instructions, either at the assembly, compiled or machine-level, to perform that process. Those instructions can be written by one of ordinary skill in the art following the description of FIGS. 3-6 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A method for sending I/O requests from an input/output processor (IOP) to an I/O device coupled to the IOP, the method comprising:
receiving a plurality of I/O requests;
queuing the plurality of I/O requests in a device queue based on the order in which the I/O requests were received;
moving I/O requests from the device queue to one of a plurality of active I/Os corresponding to a plurality of I/O threads, wherein each I/O thread is configured to transfer an I/O request from the device queue to a corresponding active I/O, and wherein the plurality of I/O threads are configured to process multiple I/O requests at a time for transmission to the I/O device;
controlling the movement of an I/O request from the device queue to one of the active I/Os based on the set of promotion requirements; and
sending multiple I/O requests processed by the plurality of I/O threads to the I/O device.

2. The method as recited in claim 1, wherein the controlling step comprises promoting an I/O request ahead of at least one other I/O request from the device queue to an active I/O based on a set of promotion requirements.

3. The method as recited in claim 1, wherein the I/O requests include data read I/O requests and data write I/O requests, and wherein the set of promotion requirements comprises a requirement that no data read I/O request can be promoted ahead of any other I/O request in the device queue if the data read I/O request overlaps a data write I/O request in any of the plurality of active I/Os or if there is an overlapping data write I/O request ahead of the data read I/O request in the device queue.

4. The method as recited in claim 1, wherein the I/O requests include data read I/O requests and data write I/O requests, and wherein the set of promotion requirements comprises a requirement that no data write I/O request can be promoted ahead of any other I/O request in the device queue if the data write I/O request overlaps a data read I/O request or another data write I/O request in any of the plurality of active I/Os or if there is an overlapping data read I/O request or an overlapping data write I/O request ahead of the data write I/O request in the device queue.

5. The method as recited in claim 1, wherein the I/O requests include data read I/O requests and data write I/O requests, and wherein the set of promotion requirements comprises a requirement that none of the plurality of active I/Os includes an I/O request that is not a data read I/O request or not a data write I/O request.

6. The method as recited in claim 1, wherein the I/O requests include data read I/O requests and data write I/O requests, and wherein the set of promotion requirements comprises a requirement that, for any I/O request that is not a data read I/O request or not a data write I/O request, there is no other I/O request before the I/O request in the device queue.

7. The method as recited in claim 1, wherein the I/O requests include data read I/O requests and data write I/O requests, and wherein the set of promotion requirements comprises a requirement that, for any I/O request that is not a data read I/O request or not a data write I/O request, there is no I/O request in any of the plurality of active I/Os.

8. The method as recited in claim 1, wherein each I/O request in the device queue has a skip count, and wherein the skip count of the corresponding I/O request is incremented by one each time the corresponding I/O request is skipped over by a promoted I/O request.

9. The method as recited in claim 8, wherein, if the skip count of an I/O request reaches a first threshold level, the I/O request cannot be skipped over by another I/O request.

10. The method as recited in claim 1, wherein at least a portion of the controlling step is performed by at least one of a queuing thread coupled to the device queue and a promotion algorithm coupled between the queuing thread and the device queue.

11. The method as recited in claim 1, wherein at least a portion of the controlling step is performed by at least one of the plurality of I/O threads.

12. An apparatus for sending I/O requests from an input/output processor (IOP) to an I/O device coupled to the IOP, the apparatus comprising:
a request queue configured for receiving I/O requests;
a device queue configured for queuing a plurality of I/O requests, the device queue having an input end and an output end;
a queuing thread coupled between the request queue and the device queue, wherein the queuing thread is configured to pull I/O requests from the request queue and deliver pulled I/O requests to the input end of the device queue;
a plurality of I/O threads for processing multiple I/O requests at a time for transmission to the I/O device; and
a plurality of active I/Os corresponding to the plurality of I/O threads and coupled between the device queue and a respective one of the I/O threads, wherein each I/O thread is configured to transfer an I/O request from the output end of the device queue to a corresponding active I/O,
wherein at least one of the queuing thread and the plurality of I/O threads are configured to promote an I/O request ahead of at least one other I/O request from the device queue to an active I/O based on a set of promotion requirements.

13. The apparatus as recited in claim 12, further comprising a promotion algorithm element configured to control the movement of an I/O request from the device queue to one of the active I/Os based on the set of promotion requirements.

14. The apparatus as recited in claim 13, wherein the promotion algorithm element is coupled between the queuing thread and the device queue.

15. The apparatus as recited in claim 13, wherein at least a portion of the promotion algorithm element is coupled to or included within at least one of the queuing thread and the plurality of I/O threads.

16. The apparatus as recited in claim 12, wherein the I/O requests include data read I/O requests and data write I/O requests, and wherein the set of promotion requirements comprises a requirement that no data read I/O request can be promoted ahead of any other I/O request in the device queue if the data read I/O request overlaps a data write I/O request in any of the plurality of active I/Os or if there is an overlapping data write I/O request ahead of the data read I/O request in the device queue.

17. The apparatus as recited in claim 12, wherein the I/O requests include data read I/O requests and data write I/O requests, and wherein the set of promotion requirements comprises a requirement that no data write I/O request can be promoted ahead of any other I/O request in the device queue if the data write I/O request overlaps a data read I/O request or another data write I/O request in any of the plurality of active I/Os or if there is an overlapping data read I/O request or an overlapping data write I/O request ahead of the data write I/O request in the device queue.

18. The apparatus as recited in claim 12, wherein the I/O requests include data read I/O requests and data write I/O requests, and wherein the set of promotion requirements comprises a requirement that none of the plurality of active I/Os includes an I/O request that is not a data read I/O request or not a data write I/O request.

19. The apparatus as recited in claim 12, wherein the I/O requests include data read I/O requests and data write I/O requests, and wherein the set of promotion requirements comprises a requirement that, for any I/O request that is not a data read I/O request or not a data write I/O request, there is no other I/O request before the I/O request in the device queue.

20. The apparatus as recited in claim 12, wherein the I/O requests include data read I/O requests and data write I/O requests, and wherein the set of promotion requirements comprises a requirement that, for any I/O request that is not a data read I/O request or not a data write I/O request, there is no I/O request in any of the plurality of active I/Os.

21. The apparatus as recited in claim 12, wherein each I/O request in the device queue has a skip count, and wherein the skip count of the corresponding I/O request is incremented by one each time the corresponding I/O request is skipped over by a promoted I/O request.

22. The apparatus as recited in claim 21, wherein the set of promotion requirements comprises a requirement that, if the skip count of an I/O request reaches a first threshold level, no other I/O request can be promoted over the I/O request having the first threshold level skip count.

23. The apparatus as recited in claim 12, wherein each active I/O is configured to determine whether or not the corresponding I/O thread is processing an I/O request.

24. The apparatus as recited in claim 23, wherein each active I/O has a first “in use” state when the corresponding I/O thread is processing an I/O request and a second “free” state when the corresponding I/O thread is not processing an I/O request.

25. The apparatus as recited in claim 12, wherein the queuing thread is configured to, in response to an I/O request being promoted from the device queue to an active I/O, activate the corresponding I/O thread for processing the I/O request received by the active I/O.

26. A computer readable medium having instructions stored thereon that, when executed by a processor, carry out a method for sending I/O requests from an input/output processor (IOP) to an I/O device coupled to the IOP, the instructions comprising:
receiving a plurality of I/O requests;
queuing the plurality of I/O requests in a device queue based on the order in which the I/O requests were received;
moving I/O requests from the device queue to one of a plurality of active I/Os corresponding to a plurality of I/O threads, wherein each I/O thread is configured to transfer an I/O request from the device queue to a corresponding active I/O, and wherein the I/O threads are configured to process multiple I/O requests at a time for transmission to the I/O device; and
controlling the movement of an I/O request from the device queue to one of the active I/Os based on the set of promotion requirements.

27. The computer readable medium as recited in claim 26, wherein controlling the movement of an I/O request comprises promoting an I/O request ahead of at least one other I/O request from the device queue to an active I/O based on a set of promotion requirements.
